(19) United States
(12) Patent Application Publication
(10) Pub. No.: US 2015/0021945 A1
(43) Pub. Date: Jan. 22, 2015

(54) SAFETY SLING

(71) Applicants: Christopher Allen Still, Evanston, IN (US); Cathy Lynn Still, Evanston, IN (US)

(72) Inventors: Christopher Allen Still, Evanston, IN (US); Cathy Lynn Still, Evanston, IN (US)

(21) Appl. No.: 13/946,050

(22) Filed: Jul. 19, 2013

(51) Int. Cl. B66C 1/18

(52) U.S. Cl. CPC B66C 1/18
USPC 294/74

(57) ABSTRACT

A safety sling is made from durable materials and is safety tested to withstand weight and securely lift items without risk of spilling or falling to the ground. The safety sling can be sized and shaped to carry various containers, for example, the safety sling can be designed to hold a cylindrical cooler, a 5-gallon pail, or the like. The safety sling can be easily used and lifted to any elevation securely without chance of breaking or becoming unbalanced.

### BACKGROUND OF THE INVENTION

The present invention relates to hoists and, more particularly, to a safety sling for hoisting items, such as water coolers, to construction workers at high elevations.

Currently, workers use ropes and duct tape to “secure” coolers and lift them. While platforms and other items can be used to add some degree of safety for lifting items, these devices are typically not well balanced or manufactured and can easily lose their load. Moreover, these devices are not specifically made for hydration lifts, they are not safety tested and approved, and they are currently not used or, if used, are not easy to use.

As can be seen, there is a need for a device that is easy to use that can solve unsafe lifting practices currently in use in various industries, such as in construction and sporting industries.

### SUMMARY OF THE INVENTION

In one aspect of the present invention, a safety sling comprises a hoist strap extending from a top end, down one side, across a bottom portion, and up an opposite side to terminate back at the top end of the safety sling; a loop formed in each end of the hoist strap; at least one ring strap disposed along an outer periphery of the safety sling, the hoist strap attached to the ring straps; at least one support strap extending from one side of the at least one ring strap, across the bottom portion of the safety sling, to an opposite side of the at least one ring strap, the at least one support strap creating a crisscross design on the bottom portion; and a top strap extending between opposite sides of the at least one ring strap.

In another aspect of the present invention, a safety sling comprises a hoist strap extending from a top end, down one side, across a bottom portion, and up an opposite side to terminate back at the top end of the safety sling; a loop formed in each end of the hoist strap; an upper ring strap and a lower ring strap disposed along an outer periphery of the safety sling, the hoist strap attached to the upper and lower ring straps; at least two support straps extending from one side of the upper ring strap, to one side of the lower ring strap, across the bottom portion of the safety sling, to an opposite side of the lower and upper ring straps, the at least one support strap creating a crisscross design on the bottom portion; and a top strap extending between opposite sides of the upper ring strap, wherein the at least one support strap and the hoist strap are attached at the bottom portion of the safety sling.

These and other features, aspects and advantages of the present invention will become better understood with reference to the following drawings, description and claims.

### BRIEF DESCRIPTION OF THE DRAWINGS

FIG. 1 is a perspective view of a safety sling, in use to carry a cooler and attached to a carrying hook, according to an exemplary embodiment of the present invention;

FIG. 2 is a perspective view of the safety sling of FIG. 1, with the cooler and carrying hook removed;

FIG. 3 is a bottom perspective view of the safety sling of FIG. 2;

FIG. 4 is a side view of the safety sling of FIG. 2; and

FIG. 5 is a cross-sectional view taken along line 5-5 of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a safety sling that is made from durable materials and is safety tested to withstand weight and securely lift items without risk of spilling or falling to the ground. The safety sling can be sized and shaped to carry various containers, for example, the safety sling can be designed to hold a cylindrical cooler, a 5-gallon pail, or the like. The safety sling can be easily used and lifted to any elevation securely without chance of breaking or becoming unbalanced.

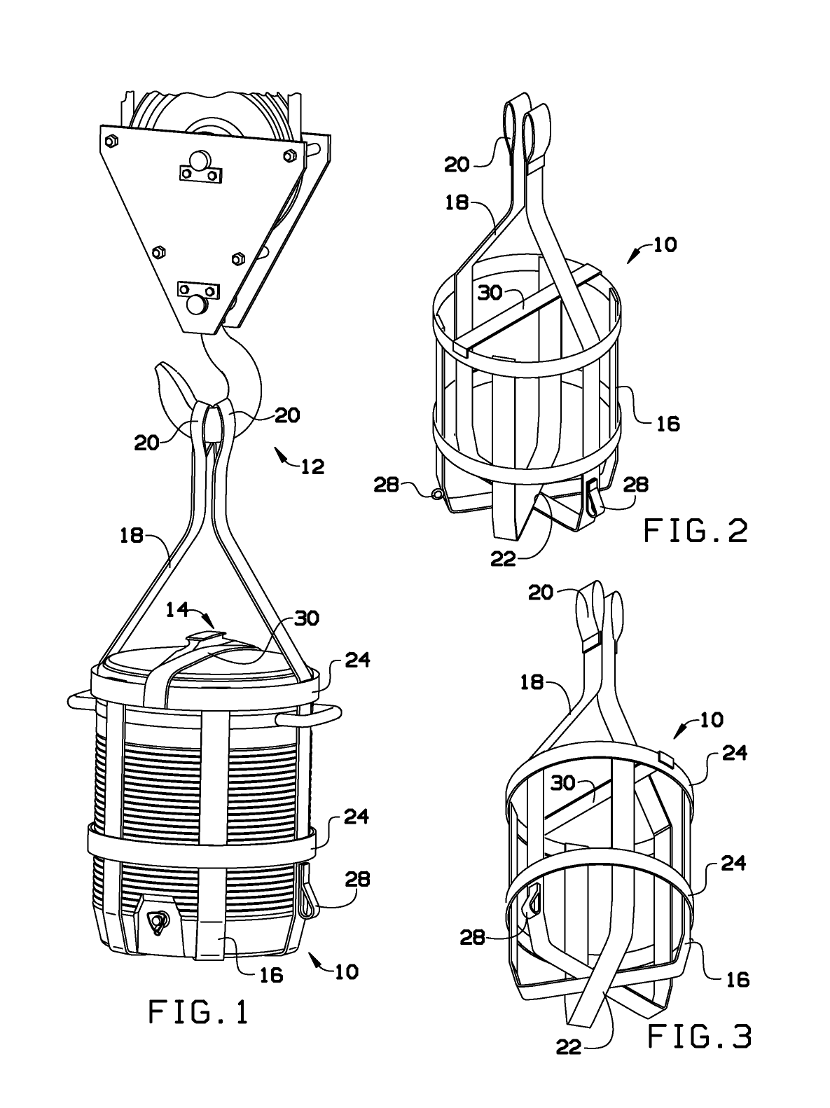

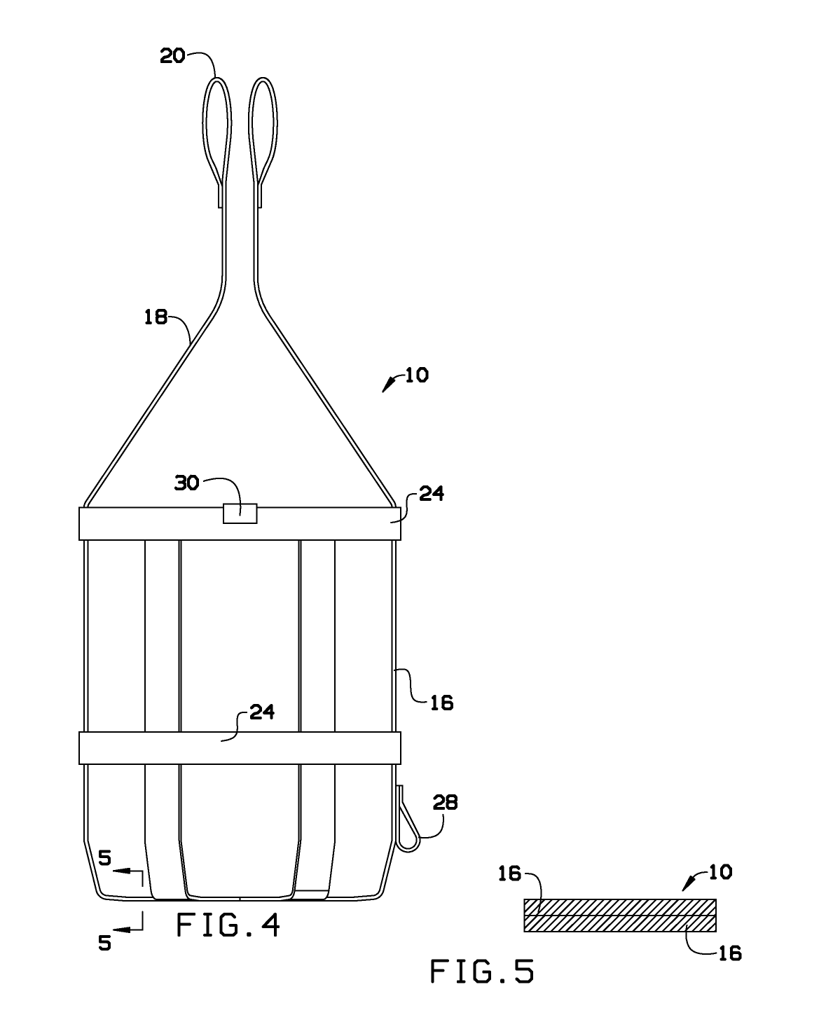

Referring now to FIGS. 1 through 5, a safety sling 10 can be attached to a crane hook 12 (or other similar lifting mechanism) and can be used to raise items, such as a cooler 14, to a desired elevation. Of course, the safety sling 10 of the present invention can be used for carrying various items, such as a pail or bucket, a container, or an optional insert that can fit into the safety sling 10 and can be used for placement of small items therein.

The safety sling 10 of the present invention can be used in various situations where lifting of items is needed. For example, the safety sling 10 can be used in construction industries for raising tools, hydration or other items to a work location. As another example, the safety sling 10 can be used for raising supplies, hydration or the like in a sporting environment, such as to a hunter positioned in a tree stand.

The safety sling 10 can be made from a hoist strap 18 that has an eye 20 formed on each end thereof. The eye 20 is typically formed from folding the end of the hoist strap 18 onto itself and stitching. Of course, other designs and methods for forming an eye in each end of the hoist strap 18 are contemplated within the scope of the present invention.

At least one ring straps 24, typically two ring straps 24, can be disposed to ring about an outer periphery of the safety sling 10. The hoist strap 18 can be stitched to each ring strap 24, at opposite sides of each ring strap 24. In other words, the hoist strap 18 begins at the top of the safety sling 10, runs down one side thereof and attaches to one side of each ring strap 24, runs across the bottom of the safety sling 10, and runs back up the other side of the safety sling 10, attaching to the opposite side of each ring strap 24.

At least one support straps 16, typically two support straps 16, can be disposed to extend from an upper one of the ring straps 24, attached thereto, down to the lower one of the ring straps 24, attached thereto, across the bottom of the safety sling 10, and back up an opposite side of the lower and upper ring straps 24, attached again to each, terminating at the upper one of the ring straps 24. This results in a crisscross bottom portion 22 of the safety sling 10. Each of the straps 16, 18, where they meet at the bottom portion 22, can be attached together, such as by stitching.

One or more tag line loops 28 can be disposed on one or more of the hoist strap 18 and the support straps 16, between the lower one of the rings straps 24 and above the bottom of the safety sling 10. The tag line loops 28 can be used to secure a line thereto to extend to the ground as the safety sling 10 is lifted.

A top strap 30 can extend from one side of the upper one of the ring straps 24 to the other side thereof. The top strap 30 can be removably connected at one or both sides of the ring strap 24. The top strap 30 can attach across the top of the safety sling 10 by various attachment means, including male and female clips, a pull-tight buckle, snaps, hook and loop fastener, or the like.

The hoist strap 18 and the support straps 16 can be made from various materials, such as polyester webbing, The straps 18, 16 can be made in an appropriate length to hold a desired container inside the safety sling 10. The straps 18, 16 can have a width from about 1 to about 4 inches, typically 2-3 inches, depending upon application.

The tag line loops 28 can be made from webbing, such as polyester webbing, stitched to one or more of the straps 18, 16 to form a loop. The webbing form the tag line loops 28 can be from about 5 to about 8 inches long and from about 1 to about 2 inches wide.

In some embodiments, the hoist strap 18 and the support straps 16 can be made from two layers of webbing, stitched together, from one side of the lower one of the ring straps 24 to the other side thereof.

The ring straps 24 themselves, can also be formed from two layers of webbing, stitched together. In some embodiments, an inner reinforcement strip (not shown) can be disposed between the two layers of webbing of the ring straps 24. The inner reinforcement strip can be made from various materials, such as plastic, vinyl, glue, resin, or the like, provided that the inner reinforcement strip provides some rigidity to the ring straps 24.

It should be understood, of course, that the foregoing relates to exemplary embodiments of the invention and that modifications may be made without departing from the spirit and scope of the invention as set forth in the following claims.

What is claimed is:

1. A safety sling comprising:
a hoist strap extending from a top end, down one side, across a bottom portion, and up an opposite side to terminate back at the top end of the safety sling;
a loop formed in each end of the hoist strap;
at least one ring strap disposed along an outer periphery of the safety sling, the hoist strap attached to the ring straps;
at least one support strap extending from one side of the at least one ring strap, across the bottom portion of the safety sling, to an opposite side of the at least one ring strap, the at least one support strap creating a crisscross design on the bottom portion; and
a top strap extending between opposite sides of the at least one ring strap.

2. The safety sling of claim 1, further comprising a tag line loop formed on at least one of the hoist strap and the at least one support strap.

3. The safety sling of claim 1, wherein the loop formed on each end of the hoist strap is formed from looping and attaching the hoist strap on itself.

4. The safety sling of claim 1, wherein the at least one ring strap includes an upper ring strap and a lower ring strap.

5. The safety sling of claim 4, wherein the at least one support strap extends from one side of the upper ring strap, across the bottom portion, to the opposite side of the upper ring strap.

6. The safety sling of claim 5, wherein the at least one support strap is formed from two straps attached together at least from the lower ring strap along the bottom portion.

7. The safety sling of claim 1, wherein the at least one support strap is two support straps.

8. The safety sling of claim 1, wherein the at least one support strap and the hoist strap are attached at the bottom portion of the safety sling.

9. A safety sling comprising:
a hoist strap extending from a top end, down one side, across a bottom portion, and up an opposite side to terminate back at the top end of the safety sling;
a loop formed in each end of the hoist strap;
an upper ring strap and a lower ring strap disposed along an outer periphery of the safety sling, the hoist strap attached to the upper and lower ring straps;
at least two support straps extending from one side of the upper ring strap, to one side of the lower ring strap, across the bottom portion of the safety sling, to an opposite side of the lower and upper ring straps, the at least one support strap creating a crisscross design on the bottom portion; and
a top strap extending between opposite sides of the upper ring strap, wherein
the at least one support strap and the hoist strap are attached at the bottom portion of the safety sling.

10. The safety sling of claim 9, further comprising a tag line loop formed on at least one of the hoist strap and the at least one support strap.

11. The safety sling of claim 9, wherein the loop formed on each end of the hoist strap is formed from looping and attaching the hoist strap on itself.

12. The safety sling of claim 9, wherein the at least two support straps are formed from two straps attached together at least from the lower ring strap along the bottom portion.

13. The safety sling of claim 9, wherein the upper and lower ring straps are formed from two layers of webbing material attached together.
